(19) United States
(12) Patent Application Publication
(10) Pub. No.: US 2025/0317531 A1
(43) Pub. Date: Oct. 9, 2025

(54) ELECTRONIC DEVICE AND METHOD FOR COMMUNICATING WITH EXTERNAL DEVICE

(71) Applicant: SAMSUNG ELECTRONICS CO., LTD., Suwon-si (KR)

(72) Inventors: Kyounghun LEE, Suwon-si (KR); Taehwan KIM, Suwon-si (KR); Seowon HAN, Suwon-si (KR)

(73) Assignee: SAMSUNG ELECTRONICS CO., LTD., Suwon-si (KR)

(21) Appl. No.: 19/244,383

(22) Filed: Jun. 20, 2025

Related U.S. Application Data
(63) Continuation of application No. PCT/KR2023/020978, filed on Dec. 19, 2023.

(30) Foreign Application Priority Data
Jan. 10, 2023 (KR) 10-2023-0003502

(51) Int. Cl. H04N 7/06; H04N 7/015

(52) U.S. Cl. CPC H04N 7/06; H04N 7/015

(57) ABSTRACT

An embodiment of the present disclosure relates to an electronic device and a method for performing, through at least two heterogeneous communication interfaces, distributed processing on control signals to be transmitted to or received from an external device. To this end, the electronic device may comprise a communication unit and at least one processor. The at least one processor is configured to identify that an external electronic device is connected through an HDMI cable, check whether the external electronic device supports a direct communication method using a wireless resource, transmit information for identifying a predetermined MAC address so as to establish wireless communication with the external electronic device according to the direct communication method based on the external electronic device supporting the direct communication method, and control the communication unit transmit, to the external electronic device through the wireless communication, at least some of the control signals to be transmitted to the external electronic device through a bidirectional serial bus terminal provided in the HDMI cable.

### CROSS REFERENCE TO RELATED APPLICATION

This application is a continuation application, under 35 U.S.C. § 111(a), of international application No. PCT/KR2023/020978, filed Dec. 19, 2023, which claims priority under 35 U.S.C. § 119 to Korean Patent Application No. 10-2023-0003502, filed Jan. 10, 2023, the disclosures of which are incorporated herein by reference in their entireties.

### TECHNICAL FIELD

The disclosure relates to an electronic device and a method capable of transmitting/receiving a control signal to/from an external device.

### BACKGROUND ART

As the performance and functions of electronic devices diversify, situations may arise in which electronic devices require connection to a number of peripheral devices, i.e. external devices. The electronic device may be provided with a connection port as an interface for connection with such an external device. The electronic device may communicate with the external device connected through the port based on a protocol predefined for the connection port.

The electronic device may be connected to an external device via the high definition multimedia interface (HDMI). The HDMI may simultaneously transfer video and audio signals in a digital scheme through a single cable. The HDMI defines the consumer electronics control (CEC) standard. The CEC standard is a standard established to enable control between devices connected via cables in addition to transmitting video data. The electronic device may transfer control data to an external device or receive control data from the external device via HDMI CEC communication.

However, since HDMI CEC communication has a limited speed, a delay may occur when sending/receiving control data when a plurality of external devices are connected in parallel to the electronic device.

### DISCLOSURE OF INVENTION

### Technical Problem

An embodiment of the disclosure may provide an electronic device and method for distributed processing of a control signal to be transmitted to or received to/from an external device through at least two heterogeneous communication interfaces.

### Solution to Problems

An electronic device according to an embodiment of the disclosure may comprise a communication unit configured to communicate with an external electronic device, and at least one processor to be electrically connected to the communication unit and configured to control the communication unit to perform communication with the external electronic device. The at least one processor while electrically connected to the communication unit may be configured to identify that the external electronic device may be connected through a high definition multimedia interface (HDMI) cable, identify whether the external electronic device supports a direct communication method using a radio resource, based on the external electronic device supporting the direct communication method, transmit information for identifying a media access control (MAC) address associated with the electronic device to the external electronic device to establish wireless communication with the external electronic device based on the direct communication method, and control the communication unit to transmit at least a portion of a control signal to be transmitted to the external electronic device through a bi-directional serial bus terminal provided in the HDMI cable, to the external electronic device through the wireless communication which is established with the electronic device.

A method for controlling an electronic device according to an embodiment of the disclosure may comprise identifying that the external electronic device is connected through an HDMI cable, identifying whether the external electronic device supports a direct communication method using a radio resource, based on the external electronic device supports the direct communication method, transmitting information identifying a MAC address associated with the electronic device to the external electronic device to establish wireless communication with the external electronic device based on the direct communication method, and transmitting at least a portion of a control signal to be transmitted to the external electronic device through a bi-directional serial bus terminal provided in the HDMI cable, to the external electronic device through the wireless communication which is established with the electronic device.

### Effects of Invention

According to an embodiment of the disclosure, it is possible to prevent a delay in communication although a plurality of external electronic devices are connected by distributed processing of a control signal to be transmitted to or received to/from an electronic device through at least two heterogeneous communication interfaces.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF DRAWINGS

FIG. 1 illustrates an example in which an electronic device is connected to an external electronic device, according to an embodiment;

FIG. 2 illustrates an example in which an electronic device is redundantly connected to an external device according to an embodiment;

FIG. 3 is a state transition diagram illustrating an electronic device according to an embodiment;

FIG. 4 illustrates a signaling procedure between an electronic device and an external electronic device according to an embodiment;

FIG. 5 is a flowchart illustrating control for transmitting a control signal by an electronic device, according to an embodiment;

FIG. 6 is a flowchart illustrating control for transmitting a control signal by an electronic device, according to an embodiment;

FIG. 7 is a flowchart illustrating control for an external electronic device to transmit or receive control signals to or from an electronic device according to an embodiment;

FIG. 8 is a block diagram illustrating an electronic device according to an embodiment;

FIG. 9 illustrates that an electronic device and an external electronic device are connected through a predetermined communication method according to an embodiment;

FIG. 10 illustrates an arrangement of a plurality of pins provided in an HDMI cable according to an embodiment; and

FIGS. 11 and 12 illustrate an example of a user interface that displays a communication state of an electronic device according to an embodiment.

In connection with the description of the drawings, the same or similar reference numerals may be used to denote the same or similar elements.

### MODE FOR THE INVENTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

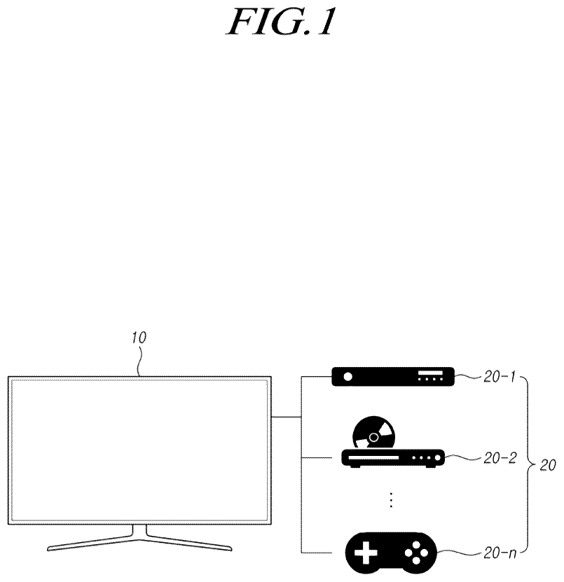

FIG. 1 illustrates an example in which an electronic device 10 is connected to an external electronic device 20 according to an embodiment of the disclosure.

Referring to FIG. 1, an electronic device 10 may be one of various types of devices. For example, the electronic device 10 may correspond to one of a TV, a smartphone, a smart pad, a tablet PC, a personal digital assistant (PDA), a laptop PC, or a desktop PC.

According to an example, the external electronic device 20 may be a device that may be connected to the electronic device 10 through a wired interface or a wireless interface. The wired interface may be a medium capable of physically connecting at least two electronic devices, such as a wired cable, or a protocol provided to allow the at least two electronic devices to communicate with each other. The wired interface may include, e.g., an HDMI interface. The wireless interface may be a medium capable of connecting at least two electronic devices based on a predetermined wireless communication method or a protocol provided to allow the at least two electronic devices to communicate with each other. The wireless interface may be, e.g., an interface supporting a Bluetooth method.

For example, the external electronic device 20 may include various types of devices such as a set-top box, an optical disc reproduction device (e.g., a blue-ray disc reproduction device or a digital versatile disc reproduction device (DVD) or a console game device. The external electronic device 20 may include a first external electronic device 20-1, a second external electronic device 20-2, or an nth external electronic device 20-n. Here, n is an integer larger than or equal to 1. The first external electronic device 20-1 may correspond to a set-top box. The second external electronic device 20-2 may correspond to an optical disc reproduction device. The nth external electronic device 20-n may correspond to a console game device. Without being limited to the illustration, the external electronic device 20 may include various types of devices that may be connected to the electronic device 10. The external electronic device 20 may include, e.g., a mobile device capable of transmitting/receiving signals or data based on a USB protocol. The external electronic device 20 may include, e.g., a source device capable of transmitting/receiving signals or data based on a display port (DP) protocol.

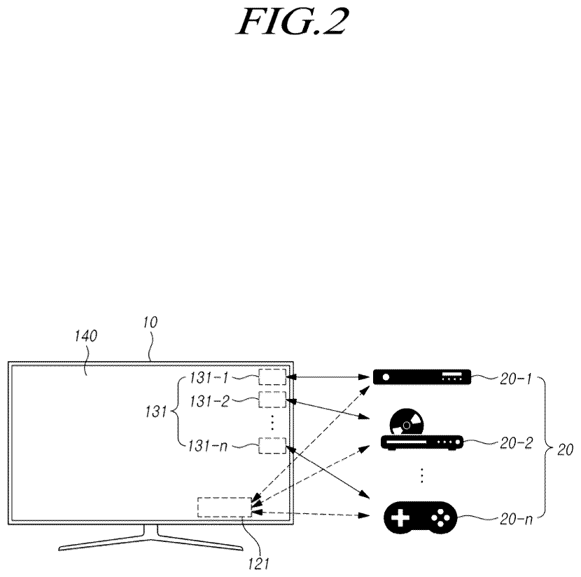

According to an example, the electronic device 10 may be physically or electrically connected to the external electronic device 20 through a wired interface. Here, the physical connection may mean a visual connection through a physical medium such as a cable. The electrical connection may mean that at least two electronic devices (e.g., the electronic device 10 and the external electronic device 20) are connected to transmit/receive electrical signals. The electronic device 10 may be provided with a connection port (e.g., the connection port 131 of FIG. 2) to which a predetermined medium (e.g., a cable) for physically or electrically connecting the external electronic device 20 may be fastened. The external electronic device 20 may be provided with a connector to which a predetermined medium (e.g., a cable) for physically or electrically connecting the electronic device 10 may be fastened corresponding to the connection port 131. The connector may be integrally formed with the external electronic device 20 or may be provided as a separate cable. When the external electronic device 20 and the connector are integrally formed, one end of the connector and the connection port 131 provided in the electronic device 10 may correspond to each other. When one end of the connector and the connection port 131 are coupled, the electronic device 10 and the external electronic device 20 may be physically or electrically connected.

According to an example, the electronic device 10 may be electrically connected to the external electronic device 20 through a wireless interface. Here, the electrical connection may mean that at least two electronic devices (e.g., the electronic devices 10, external electronic devices 20) are connected to transmit/receive electrical signals. For example, the electronic device 10 and the external electronic device 20 may include a wireless communication module therein for electrical connection. In this case, the electronic device 10 may be wirelessly connected to the external electronic device 20 through a wireless communication module. For example, the electronic device 10 and the external electronic device 20 may support a direct communication method using a radio resource. The electronic device 10 may be connected to the external electronic device 20 through a wireless direct communication method. The wireless direct communication method may be one of short-range communication methods such as Bluetooth, wireless fidelity (Wi-Fi) direct, or infrared data association (IrDA).

In this disclosure, as an embodiment, it is assumed that the wired interface between the electronic device 10 and the external electronic device 20 is an interface that provides a wired connection using an HDMI cable, and the wireless interface is an interface that provides a wireless connection using a Bluetooth method. However, the wired interface or wireless interface for the embodiment proposed in the disclosure may not necessarily be limited to a specific method or form.

FIG. 2 illustrates an example in which an electronic device 10 is redundantly connected to an external electronic device 20 according to an embodiment of the disclosure.

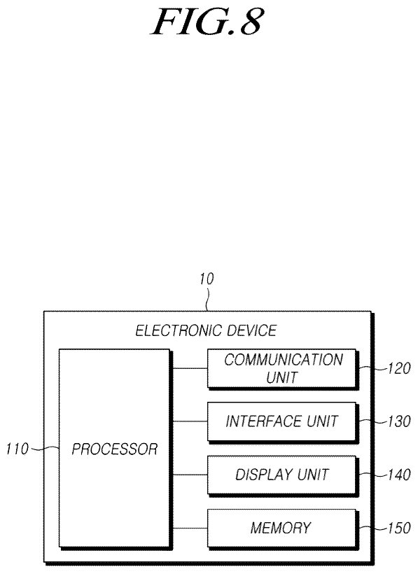

Referring to FIG. 2, the electronic device 10 may include at least one connection port 131. The electronic device 10 may be connected to at least one external electronic device 20 through a cable (indicated by a solid line) to be fastened to the connection port 131. The number of external electronic devices 20 to be connected to the electronic device 10 through the wired interface may be determined in proportion to the number of connection ports 131 provided therein. For example, the electronic device 10 may include n connection ports 131 (e.g., the first connection port 131-1, the second connection port 131-2, . . . , or the nth connection port 131-n, where n is an integer of 1 or more). The connection port 131 may be included in an interface unit (e.g., 130 of FIG. 8) provided to transmit or receive a signal according to a predetermined protocol, i.e., a predetermined standard or specification. The interface unit 130 may include a connector, a terminal, or a port as a connection means corresponding to a corresponding protocol. The connection port 131 may be an example of the connection means.

According to an example, the external electronic device 20 may include a connector (not illustrated) for physically or electrically connecting the other side of the cable with one side fastened to the connection port 131 provided in the electronic device 10. The connector may correspond to the connection port 131.

According to an example, the outer shape of the connection port 131 may correspond to a predetermined protocol. For example, the connection port 131 may be implemented to have the shape of an HDMI port as the shape corresponding to the high definition multimedia interface (HDMI) protocol. For example, the connection port may be implemented to have a shape of a USB type-C port as the shape corresponding to the universal serial bus (USB) protocol.

According to an example, the interface unit 130 including the connection port 131 having a shape corresponding to a predetermined protocol may implement an alternate mode. The alternate mode may allow the interface to transmit and/or receive signals of a plurality of different protocols. For example, an interface implementing a USB type-C alternate mode may be implemented to transmit and/or receive signals based on other protocols in addition to signals based on HDMI protocols.

In the following disclosure, a case where the connection port 131 is implemented as a connection port capable of receiving signals of the HDMI protocol and may transmit and/or receive HDMI signals is described as an example.

According to an example, the connection port 131 may include a plurality of pins. The connector of the external electronic device 20 may include a plurality of pins respectively corresponding to all or some of the plurality of pins provided in the connection port 131. The plurality of pins provided in the connection port 131 and/or the connector may be defined to transmit or receive a signal having a predetermined characteristic corresponding to any one, e.g., HDMI, of the plurality of protocols. For example, among the plurality of pins, pin 13 may be a consumer electronic control (CEC) pin used to transmit an HDMI CEC signal.

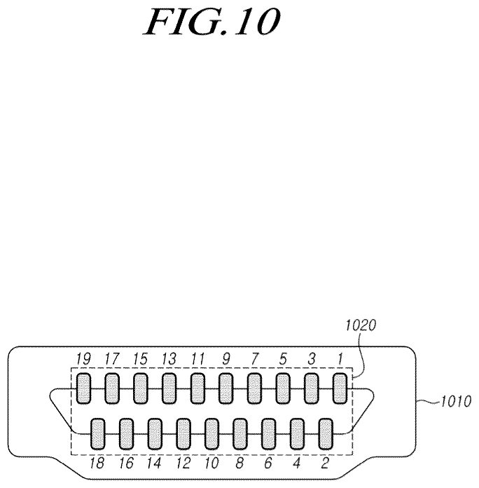

The plurality of pins including the CEC are described below in detail with reference to FIG. 10.

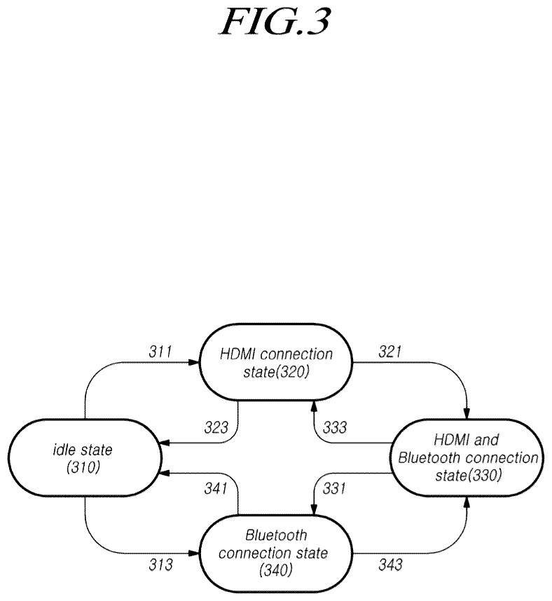

FIG. 3 is a state transition diagram illustrating an electronic device 10 according to an embodiment of the disclosure.

Referring to FIG. 3, the electronic device 10 may operate in an idle state 310 when it is not physically or electrically connected to the external electronic device 20.

According to an example, the electronic device 10 may detect a first connection event in which it is connected to an external electronic device 20 by an HDMI cable. When the HDMI cable connected to the external electronic device 20 is fastened to the connection port (e.g., the connection port 131 of FIG. 2) so that the first connection event occurs, the electronic device 10 may transition to the HDMI connection state (311). In the HDMI connection state 320, the electronic device 10 may transmit and/or receive control signals based on HDMI CEC communication (hereinafter referred to as ‘CEC communication’) with the external electronic device 20.

According to an example, the electronic device 10 may detect a first release event in which the state connected to the external electronic device 20 by the HDMI cable is released. The first release event may occur, e.g., when the HDMI cable fastened to the connection port 131 is removed or the HDMI cable fastened to the connector provided in the external electronic device 20 is removed. When the first release event occurs, the electronic device 10 may transition to the idle state 310 (323).

According to an example, the electronic device 10 may identify whether the external electronic device 20 supports a wireless direct communication method using a control signal provided from the external electronic device 20 through CEC communication. The wireless direct communication method may include, e.g., a communication method through Bluetooth. To this end, the electronic device 10 may transmit a specific control signal to the external electronic device 20 using CEC communication. The specific control signal may include, e.g., a code or an instruction arbitrarily set by the vendor. For example, the external electronic device 20 may transmit a control signal in response to a specific control signal received from the electronic device 10 to the electronic device 10 using CEC communication. The control signal responsive to the specific control signal may include, e.g., the code or instruction that may determine whether the external electronic device 20 supports the wireless direct communication method or whether it is possible to switch from the HDMI connection to the wireless direct communication method.

When a control signal is received from the external electronic device 20 in response to the specific control signal, the electronic device 10 may determine whether the external electronic device 20 supports the wireless direct communication method by the received control signal. When it is identified that the external electronic device 20 may support the wireless direct communication method, the electronic device 10 may establish wireless direct communication with the external electronic device 20. When establishing the wireless direct communication, the electronic device 10 may transmit information about a predetermined media access control (MAC) address to the external electronic device 20. The information about the MAC address may be, e.g., information necessary for the electronic device 10 to perform the wireless direct communication with the external electronic device 20. The MAC address may correspond to a unique identifier allocated to the electronic device 10 for communication between devices in the data link layer. The MAC address may be information about the unique address of the electronic device 10. The MAC address may be information configured in units of predetermined bits for wireless direct communication. The information about the MAC address mentioned below may mean information necessary for the electronic device 10 and the external electronic device 20 to establish a wireless direct communication (e.g., Bluetooth communication) connection.

According to an example, the electronic device 10 may form a connection to provide wireless direct communication with the external electronic device 20 in the HDMI connection state 320. When the electronic device 10 forms a connection to provide direct wireless communication with the external electronic device 20, it may transition to the HDMI and Bluetooth connection state (321). For example, in the HDMI and Bluetooth connection state 330, the electronic device 10 may transmit and/or receive control data using at least one of CEC communication or Bluetooth serial port profile (SPP) (hereinafter, referred to as ‘SPP communication’). For example, in the HDMI and Bluetooth connection state 330, the electronic device 10 may distribute and process transmission and/or reception of control data using CEC communication and SPP communication. For example, the electronic device 10 may transmit and/or receive at least a portion of the control data through SPP communication, and may transmit and/or receive the rest of the control data through CEC communication.

According to an example, the electronic device 10 may include predetermined identification information in at least a portion of control data transmitted through SPP communication and transmit it to the external electronic device 20. The predetermined identification information may be, e.g., information indicating that control data transmitted through SPP communication is a control signal to be transmitted through CEC communication.

According to an example, the electronic device 10 may transmit or receive a portion of the control data through CEC communication, and transmit or receive the rest of the control data through SPP communication. The electronic device 10 may, e.g., prepare a predetermined criterion for selecting a communication method to be used, and adaptively select the communication method to transmit and/or receive control data based on the prepared criterion.

For example, the electronic device 10 may determine whether to transmit the control data to the external electronic device 20 using CEC communication or SPP communication in consideration of the type of control data. The type of the control data may be classified into, e.g., first data requiring security that meets a threshold level or second data that does not. The electronic device 10 may determine to transmit the first data in the CEC communication method, and to transmit the second data in the SPP communication method. However, the disclosure is not limited thereto, and the electronic device 10 may determine to transmit the first data in the SPP communication method, and may determine to transmit the second data in the CEC communication method.

For example, the electronic device 10 may determine whether to transmit the control data to the external electronic device 20 using CEC communication or SPP communication in consideration of the amount of traffic caused by control data. The traffic amount may be, e.g., a traffic capacity as much as a threshold capacity capable of transmitting through CEC communication, or may be set to a predetermined proportion (e.g., 90%) of the traffic capacity. The electronic device 10 may mitigate the occurrence of a communication delay between the electronic device 10 and a plurality of external electronic devices 20 by distributing and transmitting the control data to the external electronic device 20 by the CEC communication method or the SPP communication method and transmitting the control data.

According to an example, the electronic device 10 may monitor the communication quality of wireless communication (e.g., the Bluetooth connection state) connected to the external electronic device 20 in the HDMI and Bluetooth connection state 330. For example, the electronic device 10 may monitor the communication quality of an SPP communication channel included in a channel established through wireless communication connected to the external electronic device 20. The wireless channel mentioned below may refer to a channel for SPP communication among channels connected through wireless communication. The electronic device 10 may disconnect the connection by the wireless channel and transition to the HDMI connection state (333) if the quality of the wireless channel connected to the external electronic device 20 is not good. The electronic device 10 may be connected to the external electronic device 20 only through HDMI in the HDMI connection state 320. For example, the electronic device 10 may detect that the connection between the external electronic device 20 and the wireless channel is disconnected by the wireless channel to detect that the quality of the wireless channel is not good. When the state transitions to the HDMI connection state 320, the electronic device 10 may transmit and/or receive all of the control signals with the external electronic device 20 using the CEC communication method.

According to an example, the electronic device 10 may monitor whether an environment where wireless direct communication with the external electronic device 20 is provided in the HDMI connection state 320. For example, the electronic device 10 may receive a signal (e.g., a probe signal) transmitted by the external electronic device 20 for wireless direct communication and identify the quality of the received signal to determine whether it is an environment capable of wireless direct communication. When an environment where wireless direct communication is possible is provided, the electronic device 10 may form a connection to provide wireless direct communication with the external electronic device 20. By forming the connection to provide the wireless direct communication, the electronic device 10 may transition from the HDMI connection state 320 to the HDMI and Bluetooth connection state 330 (321). For example, in the HDMI and Bluetooth connection state 330, the electronic device 10 may transmit and/or receive control data using at least one of CEC communication and SPP communication. For example, in the HDMI and Bluetooth connection state 330, the electronic device 10 may distribute and process transmission and/or reception of control data using CEC communication and SPP communication. For example, the electronic device 10 may transmit and/or receive at least a portion of the control data through SPP communication, and may transmit and/or receive the rest of the control data through CEC communication.

According to an example, the electronic device 10 may form a connection to provide wireless direct communication with the external electronic device 20 in response to a wireless direct communication connection request in the idle state 310. When the electronic device 10 forms a connection to provide wireless direct communication with the external electronic device 20, the electronic device 10 may transition from the idle state 310 to the Bluetooth connection state 340. The electronic device 10 may perform wireless direct communication with the external electronic device 20 after transitioning to the Bluetooth connection state 340.

According to an example, the electronic device 10 may monitor the connection state for wireless direct communication with the external electronic device 20 in the Bluetooth connection state 340. If the connection state for wireless direct communication with the external electronic device 20 is not good, the external electronic device 20 may release the connection for wireless direct communication and transition to the idle state 310 (341).

According to an example, the electronic device 10 may detect a second connection event in which it is connected to the external electronic device 20 by an HDMI cable in the Bluetooth connection state 340. When the HDMI cable connected to the external electronic device 20 is fastened to the connection port 131 so the second connection event occurs, the electronic device 10 may transition from the Bluetooth connection state 340 to the HDMI and Bluetooth connection state 330 (343). For example, in the HDMI and Bluetooth connection state 330, the electronic device 10 may transmit and/or receive control data using at least one of CEC communication and SPP communication. For example, in the HDMI and Bluetooth connection state 330, the electronic device 10 may distribute and process transmission and/or reception of control data using CEC communication and SPP communication. For example, the electronic device 10 may transmit and/or receive at least a portion of the control data through SPP communication, and may transmit and/or receive the rest of the control data through CEC communication.

According to an example, the electronic device 10 may monitor whether the cable connection with the external electronic device 20 is released in the HDMI and Bluetooth connection state 330. When the cable connecting the external electronic device 20 is removed, the electronic device 10 may transition to the Bluetooth connection state (331). The electronic device 10 may be connected to the external electronic device 20 only by wireless direct communication in the Bluetooth connection state 340.

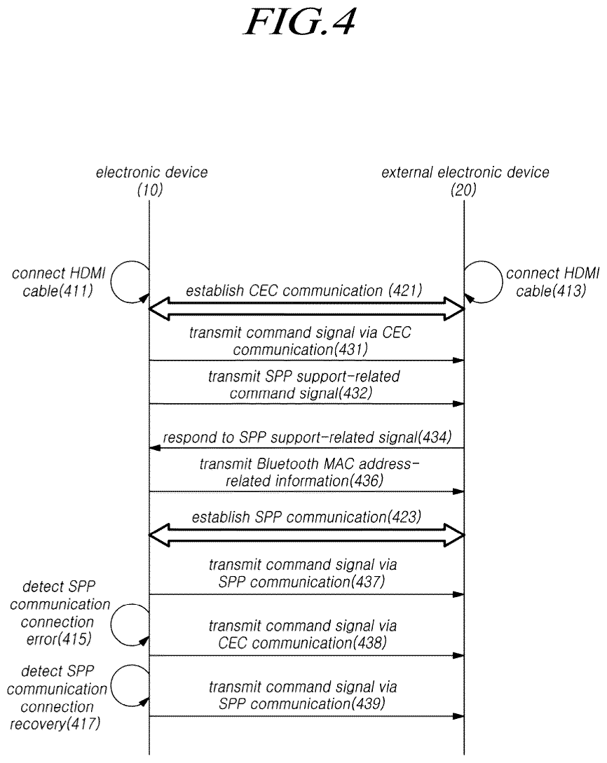

FIG. 4 illustrates a signaling procedure between an electronic device 10 and an external electronic device 20 according to an embodiment of the disclosure.

Referring to FIG. 4, in step 411, the electronic device 10 may identify that it is connected to the external electronic device 20 through an HDMI cable. In step 413, it may be identified that the external electronic device 20 is connected to the electronic device 10 through an HDMI cable.

According to an example, when the electronic device 10 and the external electronic device 20 are connected through an HDMI cable, in step 421, the electronic device 10 and the external electronic device 20 may establish CEC communication through the HDMI cable. The CEC communication may be provided through the 13th pin of HDMI.

According to an example, in step 431, the electronic device 10 may transmit a command signal to the external electronic device 20 through CEC communication. The command signal may be generated by a control signal input to the electronic device 10 by the user operating an input device (e.g., a remote control, a game pad). The command signal may be a signal for controlling the external electronic device 20 in response to the user's input. The command signal may include, e.g., a power-on/off signal, a volume control signal, or a direction button signal. Although not illustrated, the external electronic device 10 may also transmit a command signal through the CEC communication.

According to an example, in step 432, the electronic device 10 may transmit a command signal for establishing SPP communication with the external electronic device 20 to the external electronic device 20. The command signal may be a signal for asking the external electronic device 20 whether it supports SPP communication or whether it supports switching between CEC communication and SPP communication.

According to an example, in step 434, the external electronic device 20 may transmit a signal (hereinafter referred to as a ‘SP support-related response signal’) in response to the SPP support-related command signal received from the electronic device 10. The SPP support-related response signal may include, e.g., information indicating whether the external electronic device 20 supports SPP communication or whether it supports switching between CEC communication and SPP communication.

According to an example, when identifying that the external electronic device 20 supports SPP communication and supports switching between CEC communication and SPP communication based on the received response signal, in step 436, the electronic device 10 may transmit information about the MAC address for establishing SPP communication to the external electronic device 20.

According to an example, in step 423, the electronic device 10 may be connected to the external electronic device 20 through SPP communication.

According to an example, in step 437, the electronic device 10 may transmit a command signal to the external electronic device 20 through SPP communication. The electronic device 10 may include identification information in the command signal and transmit it to the external electronic device 20. The identification information may be information indicating that the command signal is a control signal to be transmitted through CEC communication.

For example, the electronic device 10 may perform transmission through at least one of CEC communication and SPP communication in consideration of the type or traffic capacity of the command signal to be transmitted to the external electronic device 20. The type of the command signal may be classified by, e.g., whether security of a threshold level or higher is required. The electronic device 10 may transmit the command signal to CEC communication, e.g., when determining that the command signal requires a threshold level or higher of security. For example, when determining that the command signal requires security below the threshold level, the electronic device 10 may transmit the command signal through SPP communication. For example, when the traffic of the command signal is determined to be larger than or equal to a threshold capacity, the electronic device 10 may transmit the command signal through SPP communication. When the electronic device 10 determines that the traffic of the command signal is less than the threshold capacity, e.g., the electronic device 10 may transmit the command signal through CEC communication.

As described above, the electronic device 10 may distribute and transmit control signals (command signals) to be transmitted to the external electronic device 20 through the first connection path by the CEC communication method and the second connection path by the SPP communication method when both CEC communication and SPP communication are possible (e.g., the HDMI and Bluetooth connection state 330 of FIG. 3).

Further, the electronic device 10 may distribute and receive control signals (command signals) to be received from the external electronic device 20 through the first connection path by the CEC communication method and the second connection path by the SPP communication method when both CEC communication and SPP communication are possible (e.g., the HDMI and Bluetooth connection state 330 of FIG. 3).

According to an example, in step 415, the electronic device 10 may determine the quality of SPP communication connected to the external electronic device 20. For example, the electronic device 10 may monitor the communication quality of an SPP communication channel included in a channel established through wireless communication connected to the external electronic device 20. When an error is detected in the SPP communication connection due to the quality of the wireless channel falling below a threshold level, in step 438, the electronic device 10 may transmit a command signal to be transmitted through SPP communication, through CEC communication.

According to an example, in step 417, the electronic device 10 may determine the quality of SPP communication connected to the external electronic device 20. When it is detected that the quality of the wireless channel is recovered above the threshold level, in step 439, the electronic device 10 may resume command signal transmission through SPP communication.

Although the transmission operation of the electronic device 10 has been described with reference to FIG. 4, the same may also apply to the reception operation of the electronic device 10. In other words, in the state in which both CEC communication and SPP communication are possible (e.g., the HDMI and Bluetooth connection state 330 of FIG. 3), it is possible to distribute and receive control signals (e.g., command signals) which are to be received from the external electronic device 20, through connections based on different communication methods.

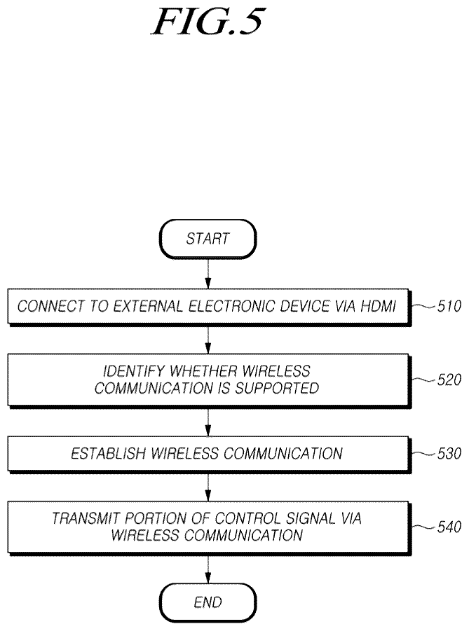

FIG. 5 is a flowchart illustrating control for the electronic device 10 to transmit a control signal according to an embodiment of the disclosure.

Referring to FIG. 5, in operation 510, the electronic device 10 may be connected to the external electronic device 20 through HDMI. The electronic device 10 may be physically or electrically connected to the external electronic device 20 through an HDMI cable. One end of the HDMI cable may be connected to a connection port (e.g., the connection port 131 of FIG. 2) provided in the electronic device 10. The other end of the HDMI cable may be connected to a connector provided in the external electronic device 20. Accordingly, the electronic device 10 may establish a CEC communication channel with the external electronic device 20. In this case, the electronic device 10 may transmit/receive control signals to/from the external electronic device 20 through the CEC communication channel. The control signal may be referred to as a command signal.

According to an example, in operation 520, the electronic device 10 may identify whether the external electronic device 20 supports wireless connection. The electronic device 10 may transmit, e.g., a Bluetooth SPP support-related command signal to the external electronic device 20. The SPP support-related command may be, e.g., a command signal asking whether the external electronic device 20 supports SPP communication or whether it supports switching between CEC communication and SPP communication. The electronic device 10 may receive an SPP support response command from the external electronic device 20 in response to the SPP support-related command. The electronic device 10 may identify whether the external electronic device 20 supports SPP communication or whether it supports switching between CEC communication and SPP communication by the received SPP support response command.

According to an example, when it is identified that the external electronic device 20 supports SPP communication or supports switching between CEC communication and SPP communication, in operation 530, the electronic device 10 may establish wireless communication (e.g., Bluetooth channel) with the external electronic device 20. For example, the electronic device 10 may transmit information about a MAC address for Bluetooth connection to the external electronic device 20.

According to an example, in operation 540, the electronic device 10 may transmit a portion of the command signals to be transmitted from the electronic device 10 to the external electronic device 20 using SPP communication supported by the wireless channel. The electronic device 10 may include identification information in the command signal transmitted using the SPP communication. The identification information may be information indicating that the command signal is a control signal to be transmitted through CEC communication.

In operation 540, the electronic device 10 may transmit a command signal that has not been transmitted using SPP communication, to the external electronic device 20 using CEC communication.

According to an example, although not illustrated, when a wireless channel is connected, the electronic device 10 may receive a portion of command signals that are to be transmitted from the external electronic device 20, using SPP communication supported by the wireless channel. The command signal received by the electronic device 10 using the SPP communication may include identification information. The identification information may be information indicating that the command signal is a control signal that should have been transmitted through CEC communication.

The electronic device 10 may receive a command signal that has not been received using SPP communication, from the external electronic device 20 using CEC communication.

In addition to those illustrated, the electronic device 10 may perform an additional operation to implement the disclosure, or at least a portion of the illustrated operations may be omitted, and at least a portion of the illustrated operations may be repeatedly performed.

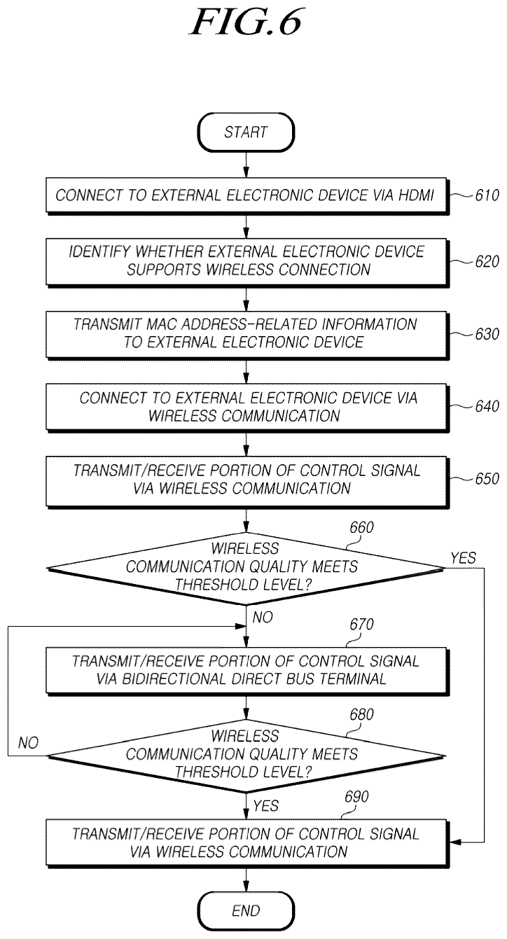

FIG. 6 is a flowchart illustrating control for an electronic device to transmit a control signal, according to an embodiment of the disclosure. Some operations of FIG. 6 may entirely or partially correspond to the operations of FIG. 5.

Referring to FIG. 6, in operation 610, the electronic device 10 may be connected to the external electronic device 20 through HDMI. Operation 610 may entirely or partially correspond to operation 510 of FIG. 5.

According to an example, in operation 620, the electronic device 10 may identify whether the external electronic device 20 supports wireless connection. The wireless connection may include Bluetooth, e.g., as a direct communication method through a radio resource. Operation 620 may entirely or partially correspond to operation 520 of FIG. 5.

According to an example, in operation 630, the electronic device 10 may transmit information about a MAC address for Bluetooth channel connection to the external electronic device 20. The electronic device 10 may transmit information about the MAC address to the external electronic device 20 based on CEC communication.

According to an example, in operation 640, the electronic device 10 may establish a wireless channel with (e.g., a Bluetooth channel) with the external electronic device 20. Operation 640 may entirely or partially correspond to operation 530 of FIG. 5.

According to an example, in operation 650, the electronic device 10 may transmit a portion of command signals to be transmitted to the external electronic device 20 through SPP communication, which is the established wireless channel. In operation 650, the electronic device 10 may receive the command signal transmitted by the external electronic device 20 through SPP communication, which is the established wireless channel. Operation 650 may entirely or partially correspond to operation 540 of FIG. 5.

For example, the electronic device 20 may transmit all of the control signals to the external electronic device 20 using CEC communication, or transmit all of the control signals to the external electronic device 20 using SPP communication.

For example, the electronic device may transmit a portion of the total control signals to be transmitted to the external electronic device 20 using CEC communication, and transmit some remaining control signals to the external electronic device 20 using SPP communication. In other words, the electronic device 10 may distribute and process the control signals through the CEC communication and the SPP communication.

For example, the electronic device 20 may receive all of the control signals from the external electronic device 20 using CEC communication, or may receive all of the control signals from the external electronic device 20 using SPP communication.

For example, the electronic device may receive a portion of the total control signals to be received from the external electronic device 20 using CEC communication, and receive some remaining control signals from the external electronic device 20 using SPP communication. In other words, the electronic device 10 may operate to distribute and receive control signals through CEC communication and SPP communication.

As an example, the electronic device 10 may transmit some control signals using CEC communication and other control signals using SPP communication in consideration of the type of command included in the control signal.

As an example, the electronic device 10 may receive some control signals using CEC communication and other control signals using SPP communication in consideration of the type of command included in the control signal.

According to an example, in operation 660, the electronic device 10 may obtain the communication quality of the established wireless channel and determine whether the obtained communication quality meets a threshold level. For example, the electronic device 10 may obtain the communication quality for the wireless channel by detecting the strength of the signal fed back from the external electronic device 20 or the arrival period of the signal.

For example, if the communication quality of the wireless channel meets the threshold level, the electronic device 10 may transmit or receive control signals to or from the external electronic device 20 in operation 690 by selecting at least one of CEC communication and SPP communication. Operation 690 may entirely or partially correspond to operation 650.

For example, if the communication quality of the wireless channel is less than the threshold level, the electronic device 10 may transmit or receive a portion of the control signals to a bi-directional serial bus terminal providing CEC communication in operation 670. The bi-directional serial bus terminal may support, e.g., HDMI CEC communication.

As an example, in operation 680, the electronic device 10 may obtain the communication quality of the established wireless channel, and determine whether the obtained communication quality meets the threshold level. When the communication quality of the wireless channel meets the threshold level, the electronic device 10 may recognize that the wireless channel has been recovered. In operation 690, the electronic device 10 may transmit some control signals through the recovered wireless channel.

In addition to those illustrated, the electronic device 10 may perform an additional operation to implement the disclosure, or at least a portion of the illustrated operations may be omitted, and at least a portion of the illustrated operations may be repeatedly performed.

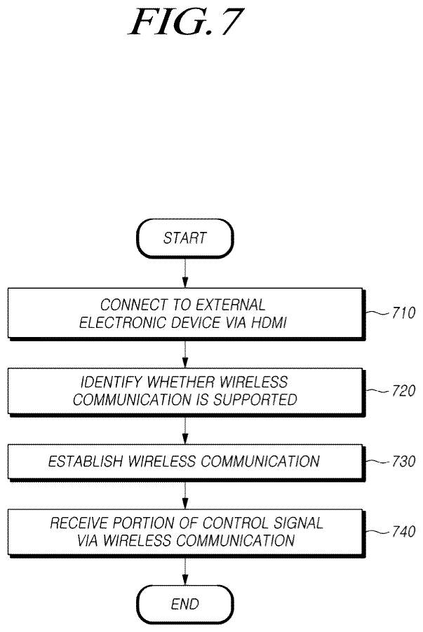

FIG. 7 is a flowchart illustrating control for an external electronic device 20 to transmit or receive control signals to or from an electronic device 10 according to an embodiment of the disclosure. Some operations of FIG. 7 may entirely or partially correspond to the operations of FIGS. 5 to 6.

Referring to FIG. 7, in operation 710, the external electronic device 20 may be connected to the electronic device 10 through HDMI. The external electronic device 20 may be physically or electrically connected to the electronic device 10 through an HDMI cable. One end of the HDMI cable may be connected to a connection port (e.g., the connection port 131 of FIG. 2) provided in the electronic device 10. The other end of the HDMI cable may be connected to a connector provided in the external electronic device 20. Accordingly, the external electronic device 20 may establish a CEC communication channel with the electronic device 10. In this case, the external electronic device 20 may transmit/receive control signals to/from the electronic device 10 through the CEC communication channel. The control signal may be referred to as a command signal.

According to an example, in operation 720, the external electronic device 20 may identify whether wireless connection is supported. The external electronic device 20 may receive, e.g., a Bluetooth SPP support-related command. The Bluetooth SPP support-related command may be, e.g., a command signal asking whether the external electronic device 20 supports SPP communication or whether it supports switching between CEC communication and SPP communication. The external electronic device 20 may transmit an SPP support response command to the electronic device 10 in response to the SPP support-related command. The external electronic device 20 may include information indicating whether the external electronic device 20 supports SPP communication or whether it supports switching between CEC communication and SPP communication in the SPP support response command.

According to an example, in operation 730, the external electronic device 20 may establish a wireless channel (e.g., a Bluetooth channel) with the electronic device 10. For example, the external electronic device 20 may receive information about a MAC address for Bluetooth channel connection from the electronic device 10. Accordingly, the external electronic device 10 may establish a wireless channel with the electronic device 10.

According to an example, in operation 740, the external electronic device 20 may receive a portion of command signals, which are control signals to be received from the electronic device 10, using SPP communication supported by the wireless channel. The external electronic device 20 may obtain identification information from the command signal received using the SPP communication. The external electronic device 20 may identify that the received command signal is a control signal that should have been transmitted using CEC communication by the obtained identification information.

In operation 740, the external electronic device 20 may receive a command signal that has not been transmitted using SPP communication from the external electronic device 20 using CEC communication.

According to an example, although not illustrated, when a wireless channel is connected, the external electronic device 20 may transmit a portion of command signals that are to be transmitted to the electronic device 10, using SPP communication supported by the wireless channel. The command signal transmitted by the external electronic device 20 using the SPP communication may include identification information. The identification information may be information indicating that the command signal is a control signal that should have been transmitted through CEC communication.

The external electronic device 20 may transmit a command signal that has not been transmitted using SPP communication to the electronic device 10 using CEC communication.

In addition to those illustrated, the external electronic device 20 may perform an additional operation to implement the disclosure, or at least some of the illustrated operations may be omitted, or at least some of the illustrated operations may be repeatedly performed.

FIG. 8 is a block diagram illustrating an electronic device 10 according to an embodiment of the disclosure.

Referring to FIG. 8, an electronic device 10 may include a processor 110, a communication unit 120, an interface unit 130, a display unit 140, or a memory 150. The electronic device 10 may add or omit components as necessary.

According to an embodiment, the processor 110 may execute software to control at least one other component (e.g., a hardware or software component) of the electronic device 10 connected with the processor 110 and may process or compute various data. For example, as at least part of the data processing or computation, the processor 110 may load a command or data received from another component (e.g., communication unit 120) onto a volatile memory, process the command or the data stored in the volatile memory, and store resulting data in a non-volatile memory. For example, the processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 10 includes the main processor and the auxiliary processor, the auxiliary processor may be configured to use lower power than the main processor or to be specified for a designated function. The auxiliary processor may be implemented separately from, or as part of, the main processor.

According to an embodiment, the auxiliary processor may control at least some of functions or states related to at least one component (e.g., the display unit 140 or the communication unit 120) of the electronic device 10, instead of the main processor while the main processor is in an inactive (e.g., sleep) state or along with the main processor while the main processor is an active state (e.g., executing an application). As an example, the auxiliary processor (e.g., an image signal processor or a communication processor) may be implemented as part of another component (e.g., the camera module 120 or the communication unit 120) functionally related to the auxiliary processor 123. As an example, the auxiliary processor (e.g., the neural processing unit) may include a hardware structure specified for artificial intelligence model processing. The artificial intelligence model may be generated via machine learning. Such learning may be performed, e.g., by the electronic device 10 where the artificial intelligence model is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

For example, the processor 110 may identify that an external electronic device 20 is connected through an HDMI cable. The processor 110 may identify whether the external electronic device 20 supports a direct communication method (e.g., a Bluetooth communication method) using a wireless resource. If the external electronic device 20 supports the direct communication method, the processor 110 may transmit information about a MAC address to the external electronic device 20 to establish a wireless channel according to the direct communication method with the external electronic device 20. The information about the MAC address may include, e.g., the MAC address of the electronic device 10 or the external electronic device 20 which is required for SPP communication. The processor 110 may control the communication unit 120 to transmit at least a portion of a control signal to be transmitted to the external electronic device 20 through a bi-directional serial bus terminal provided in the HDMI cable, to the external electronic device 20 through the wireless channel.

According to an example, the processor 110 may include identification information indicating that the control signal is a control signal to be transmitted through the bi-directional serial bus terminal in the control signal transmitted to the external electronic device 20 through the wireless channel.

According to an example, the processor 110 may determine the communication quality of the wireless channel. For example, if the communication quality of the wireless communication does not meet a threshold level, the processor 110 may control the communication unit 120 to transmit the control signal to be transmitted to the external electronic device 20 through the wireless communication, to the external electronic device 20 through the bi-directional serial bus terminal. For example, if the communication quality of the wireless communication is recovered to meet the threshold level, the processor 110 may control the communication unit 120 to transmit the control signal to be transmitted to the external electronic device 20 through the bi-directional serial bus terminal, to the external electronic device 20 through the wireless communication.

According to an example, the processor 110 may determine a transmission method according to the type of command to be transferred to the external electronic device 20. For example, if the command is a command requiring a security level above a threshold level, the processor 110 may transmit the corresponding command to the external electronic device 20 through the bi-directional serial bus terminal. For example, if the command is a command requiring a security level below the threshold level, the processor 110 may transmit the corresponding command to the external electronic device 20 through the wireless channel.

According to an example, the processor 110 may determine a transmission method in consideration of traffic of the command to be transmitted to the external electronic device 20. For example, if the amount of traffic required to transfer the instruction is above a threshold level, the processor 110 may distribute and transmit the instruction, to the external electronic device 20, through a wired channel using a bi-directional serial bus terminal and a wireless channel according to Bluetooth communication. For example, if the amount of traffic required to transmit the command is less than the threshold level, the processor 110 may transmit the instruction to the external electronic device 20 through one of the wired channel using the bi-directional serial bus terminal or the wireless channel according to Bluetooth communication.

According to an example, the communication unit 120 may establish a direct (e.g., wired) communication channel or a wireless communication channel between the electronic device 10 and the external electronic device 20 or support communication through the established communication channel. The communication unit 120 may include one or more communication processors that are operable independently from the processor 110 (e.g., the application processor (AP)) and supports a direct (e.g., wired) communication or a wireless communication. For example, the communication unit 120 may include a wireless communication module (e.g., a Bluetooth SPP communication module, a cellular communication module, a short-range wireless communication module, or a global navigation satellite system (GNSS) communication module) or a wired communication module (e.g., a CEC communication module, a local area network (LAN) communication module, or a power line communication module). A corresponding one of these communication modules may communicate with the external electronic device 20 via a first network (e.g., a short-range communication network, such as Bluetooth™, wireless-fidelity (Wi-Fi) direct, or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module may identify or authenticate the electronic device 10 in a communication network, such as the first network or the second network, using subscriber information (e.g., international mobile subscriber identity (IMSI)) stored in the subscriber identification module.

According to an example, the interface unit 130 may support one or more specified protocols to be used for the electronic device 10 to be coupled with the external electronic device 20 directly (e.g., wiredly) or wirelessly. According to an embodiment, the interface unit 130 may include, for example, a high definition multimedia interface (HDMI), a universal serial bus (USB) interface, a secure digital (SD) card interface, or an audio interface.

According to an example, a connecting terminal (e.g., the connection port 131 of FIG. 2) may include a connector via which the electronic device 10 may be physically connected with the external electronic device 20. The connection port 131 may include, for example, an HDMI connector, a USB connector, an SD card connector, or an audio connector (e.g., a headphone connector).

According to an example, the display unit 140 may visually provide information to the outside (e.g., the user) of the electronic device 10. The display unit 140 may include, e.g., a display, a hologram device, or a projector and a control circuit to control a corresponding device. For example, the display unit 140 may include a touch sensor configured to detect a touch, or a pressure sensor configured to measure the intensity of a force generated by the touch.

According to an example, the display unit 140 may display that the electronic device 10 is connected to the external electronic device 20. The display unit 140 may indicate that the electronic device 10 is in the SPP communication connection state with the external electronic device 20. For example, the display unit 140 may display a message indicating that the SPP communication state between the electronic device 10 and the external electronic device 20 is unstable. For example, the display unit 140 may display a message indicating that the SPP communication between the electronic device 10 and the external electronic device 20 is reconnected. In addition, the display unit 140 may display various messages indicating the state of the electronic device 10 according to the disclosure.

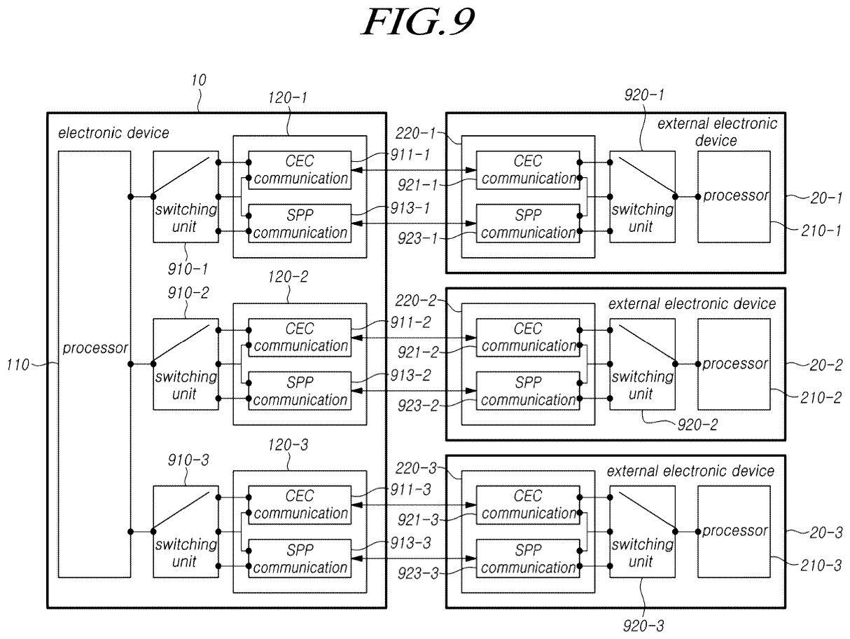

FIG. 9 illustrates that an electronic device 10 and an external electronic device 20 are connected through a predetermined communication method according to an embodiment of the disclosure. FIG. 9 conceptually illustrates the connection between the electronic device 10 and the external electronic device 20 wiredly or wirelessly.

Referring to FIG. 9, the electronic device 10 and the external electronic device 20 may be connected to each other through a wired link or a wireless link. In FIG. 9, the external electronic device 20 may include a first external electronic device 20-1, a second external electronic device 20-2, or a third external electronic device 20-3. In addition to those illustrated, the external electronic device 20 may include an additional external electronic device, but for convenience of description, it is assumed that the external electronic device 20 includes first to third external electronic devices 20-1, 20-2, and 20-3. In addition, the electronic device 10 or the external electronic device 20 may additionally include components other than those illustrated, or some of the components illustrated may be omitted.

According to an embodiment, the electronic device 10 may include a processor 110, a switching unit 910, or a communication unit 120. The communication unit 120 may include a first communication unit 120, a second communication unit 120-2, or a third communication unit 120-3. For example, the communication unit 120 may include a CEC communication module 911 or an SPP communication module 913. The CEC communication module 911 or the SPP communication module 913 may be implemented integrally or individually. The CEC communication module 911 may support CEC communication between the electronic device 10 and the external electronic device 20. The CEC communication module 911 may include, e.g., a first CEC communication module 911-1, a second CEC communication module 911-2, or a third CEC communication module 911-3. The SPP communication module 913 may support SPP communication between the electronic device 10 and the external electronic device 20. The SPP communication module 913 may include, e.g., a first SPP communication module 913-1, a second SPP communication module 913-2, or a third SPP communication module 913-3.

According to an example, the switching unit 910 may be physically or electrically connected to the CEC communication module 911 and/or the SPP communication module 913. The switching unit 910 may be physically or electrically connected to the processor 110. The switching unit 910 may be integrally formed with the processor 110 or may be formed individually. When the switching unit 910 is integrally formed with the processor 110, it may be implemented in software. In this case, the switching unit 910 is not provided as a separate hardware component, but may be implemented by distributing signals transferred by the processor 110. When the switching unit 910 is formed individually from the processor 110, it may be implemented in hardware. In this case, the switching unit 910 may be switched according to a signal transferred from the processor 110. Hereinafter, for convenience of description, a case where the switching unit 910 is implemented in hardware is described as an example. The switching unit 910 may include a first switching unit 910-1, a second switching unit 910-2, or a third switching unit 910-3. The first switching unit 910-1th may be electrically or physically connected to the first communication unit 120-1. The second switching unit 910-2th may be electrically or physically connected to the second communication unit 120-2. The third switching unit 910-3th may be electrically or physically connected to the third communication unit 120-3.

According to an example, the switching unit 910 may switch a communication method of a control signal to be transferred from the electronic device 10 to the external electronic device 20. For example, the switching unit 910 may switch to transmit a control signal through CEC communication, switch to transmit a control signal through SPP communication, or switch to distribute a control signal through SPP and CEC communication.

According to an embodiment, the first to third external electronic devices 20-1, 20-2, and 20-3 may include processors 210-1, 210-2, 210-3, switching units 920-1, 920-2, and 920-3, or communication units 220-1, 220-2, and 220-3, respectively. Hereinafter, components of the first to third external electronic devices 20-1, 20-2, and 20-3 may correspond to each other, and thus the first external electronic device 20-1 is described as an example for convenience of description.

According to an example, the communication unit 220-1 of the first external electronic device 20-1 may include the CEC communication module 921-1 or the SPP communication module 923-1. For example, the CEC communication module 921-1 may be physically or electrically connected to the first CEC communication module 911-1 of the electronic device 10. The CEC communication module 921-1 and the first CEC communication module 911-1 of the electronic device 10 may be connected through, e.g., a bi-directional serial bus terminal (e.g., an HDMI cable). For example, the SPP communication module 923-1 may be connected to the first SPP communication module 913-1 of the electronic device 10. The SPP communication module 923-1 and the first CEC communication module 911-1 of the electronic device 10 may be connected through, e.g., a wireless direct communication method (e.g., Bluetooth).

According to an embodiment, the electronic device 10 and the first external electronic device 20-1 may be connected to each other through an HDMI cable. By connecting the HDMI cable, the first CEC communication module 911-1 of the electronic device 10 and the CEC communication module 921-1 of the first external electronic device 20-1 may be connected. The electronic device 10 may transmit/receive a control signal through CEC communication through the connected bi-directional serial bus terminal (e.g., a CEC communication channel).

According to an example, the electronic device 10 may transmit a control signal related to SPP through a bi-directional serial bus terminal. The SPP-related control signal may be a signal for identifying whether the first external electronic device 20-1 supports SPP communication or whether the first external electronic device 20-1 supports switching between CEC communication and SPP communication.

According to an example, the first external electronic device 20-1 may transmit a predetermined signal in response to the SPP-related control signal to the electronic device 10 through the CEC communication channel. The electronic device 10 receiving the response signal may transmit information about a predetermined MAC address for establishing SPP communication with the first external electronic device 20-1. Thus, SPP communication between the electronic device 10 and the first external electronic device 20-1 may be established.

According to an example, the electronic device 10 and the first external electronic device 20-1 may transmit/receive a control signal by selecting at least one of a CEC communication channel or an SPP communication channel. The electronic device 10 or the first external electronic device 20-1 may transmit a portion of the control signals through CEC communication and another portion of the control signals through SPP communication. The electronic device 10 or the first external electronic device 20-1 may distribute and transmit the control signals through CEC communication or SPP communication in consideration of the type or traffic of the control signal. For example, if the control signal is an instruction requiring a security level above a threshold level, the electronic device 10 or the first external electronic device 20-1 may transmit the instruction through the bi-directional serial bus terminal. For example, if the control signal is an instruction requiring a security level below the threshold level, the electronic device 10 or the first external electronic device 20-1 may transmit the instruction through the wireless channel. For example, when the control signal has traffic above a threshold level, the electronic device 10 or the first external electronic device 20-1 may transmit the corresponding control signal through a bi-directional serial bus terminal. For example, if the control signal has traffic below the threshold level, the electronic device 10 or the first external electronic device 20-1 may transmit the corresponding control signal through the wireless communication channel.

According to an example, the electronic device 10 or the first external electronic device 20-1 may monitor the connection state (or communication quality) of SPP communication. For example, when the communication quality of the SPP communication meets the threshold level, the electronic device 10 or the first external electronic device 20-1 may select at least one of CEC communication and SPP communication to transmit a control signal. For example, if the communication quality of the SPP communication is less than the threshold level, the electronic device 10 or the first external electronic device 20-1 may transmit/receive some control signals based on CEC communication. For example, when it is identified that the wireless channel has been recovered, the electronic device 10 or the first external electronic device 20-1 may resume the operation of transmitting some control signals based on SPP communication.

FIG. 10 illustrates an arrangement of a plurality of pins provided in an HDMI cable according to an embodiment of the disclosure.

Referring to FIG. 10, connectors 1010 may be provided at two opposite ends of the HDMI cable 200. The plurality of pins 1020 may be formed in the connector 1010. For example, 19 pins 1 to 19 may be formed. A signal to be transmitted may be allocated to each of the 19 pins according to the HDMI standard. A channel may be formed by connecting pins at two opposite ends having the same number. The signal allocated to each pin may be transmitted through the formed channel.

TABLE 1

| Pin | Signal |
|---|---|
| 1 | TMDS Data 2+ |
| 2 | TMDS Data 2 shield |
| 3 | TMDS Data 2− |
| 4 | TMDS Data 1+ |
| 5 | TMDS Data 1 shield |
| 6 | TMDS Data 1− |
| 7 | TMDS Data 0+ |
| 8 | TMDS Data 0 shield |
| 9 | TMDS Data 0− |
| 10 | TMDS Clock+ |
| 11 | TMDS Clock shield |
| 12 | TMDS Clock− |
| 13 | CEC |
| 14 | Reserves (N.C. on |
| | device) |
| 15 | SCL |
| 16 | SDA |
| 17 | DDC/CEC Ground |
| 18 | +5 Power |
| 19 | Hot Plug Detect |

Table 1 is a diagram illustrating the signal transmitted by each pin of the HDMI cable.

Referring to Table 1, pins 1 to 12 are transition minimized differential signaling (hereinafter referred to as TMDS) pins used to transmit TMDS signals. TMDS is a transmission standard for transmitting high-speed digital data farther by minimizing loss, and TMDS signals may be composed of 0, 1, 2, and clock signals. For example, during RGB output, a blue (B) signal may be transmitted if the TMDS signal is 0, a green (G) signal if the TMDS signal is 1, and a red (R) signal if the TMDS signal is 2. The TMDS clock signal maintains a synchronization state and may serve to configure the HDMI signal. The content signal may be transmitted through the TMDS channel formed by pins 1 to 12. Pin 13 corresponds to a consumer electronics control (CEC) pin used to transmit CEC signals. The display unit 140 included in the electronic device 10 according to an example may transfer a control signal input from a control device (e.g., a remote controller, a joystick) to the external electronic device 20 through a CEC communication channel. In other words, the control signal may also be transferred through the CEC communication channel that transfers the content signal without using a separate cable for transferring the control signal.

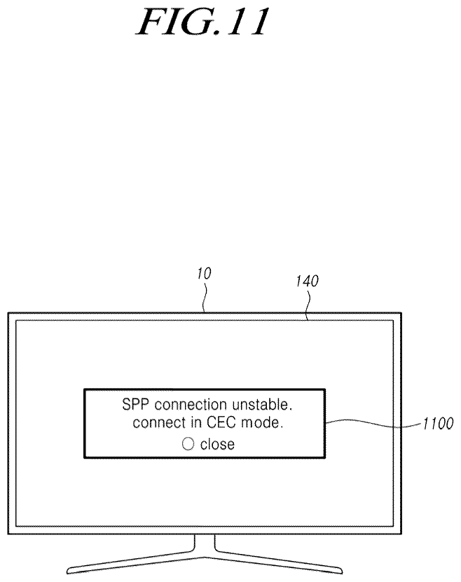

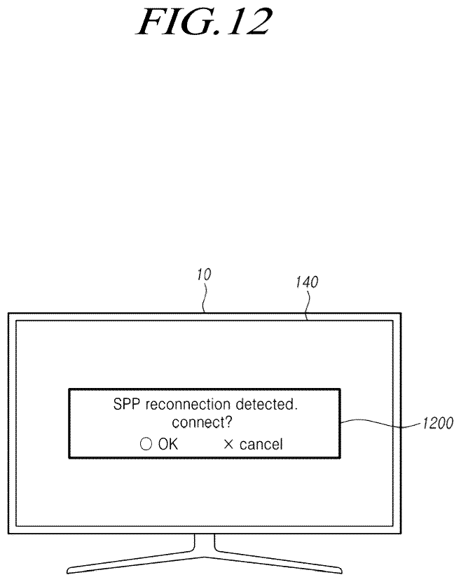

FIGS. 11 to 12 illustrate an example of a user interface displaying a communication state of an electronic device 10 according to an embodiment of the disclosure.

Referring to FIGS. 11 to 12, the user interface 1100 or 1200 may be displayed on the display unit 140 of the electronic device 10. The user interface 1100 may be output to indicate a communication state of the electronic device 10. The user interfaces 1100 and 1200 may include, e.g., a first user interface 1100 or a second user interface 1200.

According to an example, the electronic device 10 may monitor a communication state of a wireless channel connected to the external electronic device 20. The wireless channel may be, e.g., a communication channel formed based on SPP communication. When it is detected that the communication quality of the wireless channel connected to the external electronic device 20 is poor, the electronic device 10 may transmit/receive some control signals through the bi-directional serial bus terminal. The bi-directional serial bus terminal may support, e.g., CEC communication.

According to an example, when it is detected that the quality of the SPP communication wirelessly connected to the external electronic device 20 is not good, the electronic device 10 may output a message indicated by the first user interface 1100 on the display unit 140. The electronic device 10 may output a message indicated by the first user interface 1100 as a voice through an audio module (e.g., a speaker) provided in the electronic device 10.

According to an example, when it is detected that the external electronic device 20 is connected again through the SPP communication, the electronic device 10 may output a message indicated by the second user interface 1200 on the display unit 140. The electronic device 10 may output a message indicated by the second user interface 1200 as a voice through an audio module (e.g., a speaker) provided in the electronic device 10. Although not illustrated, the first or second user interface 1100 and 1200 may be output through a display unit or an audio module provided in the external electronic device 20.

According to an example, while outputting the user interfaces 1100 and 1200, the electronic device 10 may selectively control to stop or play image content to be output to the display unit 140. The electronic device 10 may control to stop or play the image data according to a pre-input setting.

According to an example, the electronic device 10 may obtain a feedback signal corresponding to the user interfaces 1100 and 1200 displayed on the display unit 140. For example, the feedback signal may be generated by the user's manipulation (touch or pressing) of an input unit provided in an input device (e.g., a remote control, a console game pad). For example, the first user interface 1100 output to the display unit 140 may be switched into an image content screen by a feedback signal generated by the user pressing an ‘O’ button or an ‘OK’ button corresponding to the first user interface 1100. For example, the electronic device 10 may switch to an image content screen by a feedback signal generated by the user pressing an ‘X’ button or a ‘cancel’ button corresponding to the second user interface 1200. For example, the electronic device 10 may control to connect through SPP communication by a feedback signal generated by the user pressing the ‘O’ button or ‘OK’ button corresponding to the second user interface 1200.

Although not illustrated, according to an embodiment of the disclosure, the user interfaces 1100 and 1200 may include various messages.

An electronic device 10 according to an embodiment of the disclosure may comprise a communication unit 120 configured to communicate with an external electronic device 20, and at least one processor 110 electrically connected to the communication unit 120 and configured to control the communication unit 120 to perform communication with the external electronic device 20. The at least one processor 110 may be configured to identify that the external electronic device 20 may be connected through an HDMI cable, identify whether the external electronic device 20 supports a direct communication method using a radio resource, if the external electronic device 20 supports the direct communication method, transmit information for identifying a MAC address to the external electronic device 20 to establish wireless communication with the external electronic device 20 based on the direct communication method, and control the communication unit 120 to transmit at least a portion of a control signal to be transmitted to the external electronic device 20 through a bi-directional serial bus terminal provided in the HDMI cable, to the external electronic device 20 through the wireless communication.

In the electronic device 10 according to an embodiment of the disclosure, a control signal transmitted to the external electronic device 20 through the wireless communication may include identification information indicating that it may be the control signal to be transmitted through the bi-directional serial bus terminal.

In the electronic device 10 according to an embodiment of the disclosure, the at least one processor 110 may be configured to, if a communication quality of the wireless communication does not meet a threshold level, control the communication unit 120 to transmit the control signal to be transmitted to the external electronic device 20 through the wireless communication, to the external electronic device 20 through the bi-directional serial bus terminal.

In the electronic device 10 according to an embodiment of the disclosure, the at least one processor 110 may be configured to, if the communication quality of the wireless communication is recovered to meet the threshold level, control the communication unit 120 to transmit the control signal to be transmitted to the external electronic device 20 through the bi-directional serial bus terminal, to the external electronic device 20 through the wireless communication.

In the electronic device 10 according to an embodiment of the disclosure, the at least one processor 110 may be configured to, determine whether to transfer a control signal corresponding to an instruction to be transferred to the external electronic device 20 through the bi-directional serial bus terminal or through the wireless communication, considering a type of the instruction.

In the electronic device 10 according to an embodiment of the disclosure, the instruction to be transmitted to the external electronic device 20 through the bi-directional serial bus terminal may be an instruction requiring a security level not less than a threshold level.

In the electronic device 10 according to an embodiment of the disclosure, the instruction to be transmitted to the external electronic device 20 through the wireless communication may be an instruction requiring a relatively lower security level as compared with the instruction to be transmitted through the bi-directional serial bus terminal.

In the electronic device 10 according to an embodiment of the disclosure, the at least one processor 110 may be configured to determine whether to transfer a control signal corresponding to an instruction to the external electronic device 20 through the bi-directional serial bus terminal or through the wireless communication, considering an amount of traffic caused by the control signal to be transferred to the external electronic device 20.

In the electronic device 10 according to an embodiment of the disclosure, the direct communication method may be a Bluetooth method.

In the electronic device 10 according to an embodiment of the disclosure, the at least one processor 110 may be configured to control the communication unit 120 to receive at least a portion of a control signal be received from the external electronic device 20 through the bi-directional serial bus terminal, from the external electronic device 20 through the wireless communication.

A method by which an electronic device (10) performs communication with an external electronic device (20), according to an embodiment of the disclosure, may comprise identifying (510) that the external electronic device (20) is connected through an HDMI cable, obtaining (520) whether the external electronic device (20) supports a direct communication method using a radio resource, if the external electronic device (20) supports the direct communication method, transmitting (530) information for identifying a MAC address to the external electronic device (20) to establish wireless communication with the external electronic device (20) based on the direct communication method, and transmitting (540) at least a portion of a control signal to be transmitted to the external electronic device (20) through a bi-directional serial bus terminal provided in the HDMI cable, to the external electronic device (20) through the wireless communication.

In the method by which the electronic device 10 performs communication with the external electronic device 20 according to an embodiment of the disclosure, a control signal transmitted to the external electronic device (20) through the wireless communication may include identification information indicating that it may be the control signal to be transmitted through the bi-directional serial bus terminal.

The method by which the electronic device 10 performs communication with the external electronic device 20 according to an embodiment of the disclosure may comprise, if a communication quality of the wireless communication does not meet a threshold level, transmitting (670) the control signal to be transmitted to the external electronic device (20) through the wireless communication, to the external electronic device (20) through the bi-directional serial bus terminal.

The method by which the electronic device 10 performs communication with the external electronic device 20 according to an embodiment of the disclosure may comprise, if the communication quality of the wireless communication is recovered to meet the threshold level, transmitting (690) the control signal to be transmitted to the external electronic device (20) through the bi-directional serial bus terminal, to the external electronic device (20) through the wireless communication.

The method by which the electronic device 10 performs communication with the external electronic device 20 according to an embodiment of the disclosure may comprise determining whether to transfer a control signal corresponding to an instruction to be transferred to the external electronic device through the bi-directional serial bus terminal or through the wireless communication, considering a type of the instruction.

In the method by which the electronic device 10 performs communication with the external electronic device 20 according to an embodiment of the disclosure, the instruction to be transmitted to the external electronic device 20 through the bi-directional serial bus terminal may be an instruction requiring a security level not less than a threshold level.

In the method by which the electronic device 10 performs communication with the external electronic device 20 according to an embodiment of the disclosure, the instruction to be transmitted to the external electronic device 20 through the wireless communication may be an instruction requiring a relatively lower security level as compared with the instruction to be transmitted through the bi-directional serial bus terminal.

The method by which the electronic device 10 performs communication with the external electronic device 20 according to an embodiment of the disclosure may comprise determining whether to transfer a control signal corresponding to an instruction to the external electronic device 20 through the bi-directional serial bus terminal or through the wireless communication, considering an amount of traffic caused by the control signal to be transferred to the external electronic device 20.

In the method by which the electronic device 10 performs communication with the external electronic device 20 according to an embodiment of the disclosure, the direct communication method may be a Bluetooth method.

The method by which the electronic device 10 performs communication with the external electronic device 20 according to an embodiment of the disclosure may comprise receiving 650 at least a portion of a control signal be received from the external electronic device 20 through the bi-directional serial bus terminal, from the external electronic device 20 through the wireless communication.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 10). For example, a processor (e.g., the processor 110) of the machine (e.g., the electronic device 10) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication unit configured to communicate with an external electronic device; and
at least one processor, to be electrically connected to the communication unit, configured to control the communication unit to perform communication with the external electronic device, wherein the at least one processor while electrically connected to the communication unit is configured to:
identify that the external electronic device is connected through a high definition multimedia interface (HDMI) cable;
identify whether the external electronic device supports a direct communication method using a radio resource;
based on the external electronic device being identified as supporting the direct communication method, transmit information identifying a media access control (MAC) address associated with the electronic device to the external electronic device to establish a wireless communication with the external electronic device based on the direct communication method; and
control the communication unit to transmit at least a portion of a control signal to be transmitted to the external electronic device through a bi-directional serial bus terminal provided in the HDMI cable, to the external electronic device through the wireless communication which is established with the electronic device.

2. The electronic device of claim 1, wherein the portion of the control signal transmitted to the external electronic device through the wireless communication includes identification information indicating the control signal is to be transmitted through the bi-directional serial bus terminal.

3. The electronic device of claim 1, wherein the at least one processor is configured to:
based on a communication quality of the wireless communication being less than a threshold level, control the communication unit to transmit the control signal to be transmitted to the external electronic device through the wireless communication, to the external electronic device through the bi-directional serial bus terminal.

4. The electronic device of claim 3, wherein the at least one processor is configured to:
based on the communication quality of the wireless communication recovering to meet the threshold level, control the communication unit to transmit the control signal to be transmitted to the external electronic device through the bi-directional serial bus terminal, to the external electronic device through the wireless communication.

5. The electronic device of claim 1, wherein the at least one processor is configured to:
determine whether to transmit a control signal corresponding to an instruction to the external electronic device through the bi-directional serial bus terminal or through the wireless communication, considering a type of the instruction.

6. The electronic device of claim 5, wherein the instruction is determined to be transmitted to the external electronic device through the bi-directional serial bus terminal based on the instruction requiring a security level not less than a threshold level.

7. The electronic device of claim 5, wherein the instruction is determined to be transmitted to the external electronic device through the wireless communication based on the instruction requiring a security level that is lower as compared a security level through the bi-directional serial bus terminal.

8. The electronic device of claim 1, wherein the at least one processor is configured to:
determine whether to transmit a control signal corresponding to an instruction to the external electronic device through the bi-directional serial bus terminal or through the wireless communication, considering an amount of traffic caused by the control signal to be transmitted to the external electronic device.

9. The electronic device of claim 1, wherein the direct communication method is a Bluetooth method.

10. The electronic device of claim 1, wherein the at least one processor is configured to:
control the communication unit to receive at least a remaining portion of the control signal be received from the external electronic device through the bi-directional serial bus terminal, from the external electronic device through the wireless communication.

11. A method by which an electronic device performs communication with an external electronic device, the method comprising:
identifying that the external electronic device is connected through an HDMI cable;
obtaining whether the external electronic device supports a direct communication method using a radio resource;
based on the external electronic device being identified as supporting the direct communication method, transmitting information for identifying a MAC address associated with the electronic device to the external electronic device to establish wireless communication with the external electronic device based on the direct communication method; and
transmitting at least a portion of a control signal to be transmitted to the external electronic device through a bi-directional serial bus terminal provided in the HDMI cable, to the external electronic device through the wireless communication which is established with the electronic device.

12. The method of claim 11, wherein the portion of the control signal transmitted to the external electronic device through the wireless communication includes identification information indicating the control signal is to be transmitted through the bi-directional serial bus terminal.

13. The method of claim 11, comprising:
based on a communication quality of the wireless communication being less than a threshold level, transmitting the control signal to be transmitted to the external electronic device through the wireless communication, to the external electronic device through the bi-directional serial bus terminal.

14. The method of claim 13, comprising:
based on the communication quality of the wireless communication recovering to meet the threshold level, transmitting the control signal to be transmitted to the external electronic device through the bi-directional serial bus terminal, to the external electronic device through the wireless communication.

15. The method of claim 11, comprising determining whether to transmit a control signal corresponding to an instruction to the external electronic device through the bi-directional serial bus terminal or through the wireless communication, considering a type of the instruction.
